(19) United States
(12) Patent Application Publication
(10) Pub. No.: US 2022/0307098 A1
(43) Pub. Date: Sep. 29, 2022

(54) METHOD TO REMOVE COPPER FROM STEEL, AND CORRESPONDING ADDITIVE

(71) Applicant: DANIELI & C. OFFICINE MECCANICHE S.P.A., Buttrio (IT)

(72) Inventors: Alessandra PRIMAVERA, Faedis (IT); Emanuele TRUCILLO, Udine (IT)

(21) Appl. No.: 17/597,183

(22) PCT Filed: Jun. 25, 2020
(86) PCT No.: PCT/EP2020/067937

§ 371 Date: Dec. 28, 2021

(30) Foreign Application Priority Data
Jun. 28, 2019 (IT) 10 2019 000010359

(51) Int. Cl. C21C 7/072; C21C 7/10; C21C 7/00

(52) U.S. Cl. CPC C21C 7/072; C21C 7/10; C21C 7/0056

(57) ABSTRACT

Method to remove copper from a bath of molten metal material, by using a reactive additive to remove copper from a bath of molten metal material and applying a depression.

### FIELD OF THE INVENTION

Embodiments described here concern a method to remove copper from a liquid bath of molten metal material, in particular molten steel, by using a reactive additive. The method and the additive are preferably but not exclusively to be used in the steel industry, within the production methods of cast metal products, starting from molten metal material.

### BACKGROUND OF THE INVENTION

In the steel industry, methods to produce metal products by casting are known, starting from a bath of molten metal material.

In these processes, the use of metal scrap to feed the bath is advantageous, as it allows to reuse waste metal products, thus reducing the environmental impact due to the disposal thereof, and above all reducing production costs, as the scrap is directly, or almost directly, available for melting, unlike iron ores, which require elaborate separation operations.

Examples of such processes are the production processes which use an electric arc furnace (EAF), in which the metal material is melted by electrodes, forming the bath of molten metal material which is then cast to form the metal products.

However, feeding the bath with scrap also entails problems, including the control of the concentration of copper (Cu).

In fact, scrap contains fractions with a high concentration of Cu, for example contained in motors, electric wires, electric and/or electronic components and devices, scrap from the automotive industry, or in general from materials that include copper as an electrical conductor and also other applications where the use of copper is envisaged.

The presence of copper in the metal products obtained at the end of production processes from scrap, while increasing resistance to corrosion and mechanical resistance, leads to a significant loss of ductility.

This loss of ductility results in a greater difficulty in rolling metal products after casting, and in the emergence of defects in the metal products, with a consequent reduction in the final quality.

For example, in the production of carbon and low alloy steels, the tolerance on the presence of copper typically fluctuates between 0.2% and 0.5%, and exceeding these limits entails a worsening of the mechanical characteristics of the steel, which gradually increases with the concentration of copper.

Some known methods for controlling the concentration of copper in metal products provide to reduce as much as possible the fraction of copper contained in the scrap upstream of melting, separating the fraction of copper contained in the scrap either mechanically or also magnetically.

However, these solutions do not solve the problem since, especially due to the growing miniaturization of the electronic components, it is very difficult to eliminate the copper in satisfactory percentages.

Furthermore, these methods cannot be applied in cases where the copper is present in the scrap in the form of alloys or coatings.

Known methods which allow to overcome these disadvantages provide to reduce the concentration of copper directly in the bath of molten metal material, following the melting of the metal material from scrap.

These methods can comprise methods to dilute the bath or methods to remove the copper.

The former typically provide to add to the bath of molten metal material a fraction of pure diluting material, which does not contain copper, or in any case low in copper, for example DRI/HBI (Direct Reduced Iron/Hot Briquetted Iron) or cast iron. This operation causes a dilution of the bath, with a consequent reduction in the concentration of copper.

This solution, however, entails considerable production costs associated with the pure diluting material. Furthermore, in the complete absence, or even in the event of temporary unavailability of the pure diluting material, it is not possible to reduce the concentration of copper, and therefore the metal products obtained must be downgraded due to their concentration of copper.

Known methods to remove copper, which provide to separate the copper from the metal bath by means of a chemical-physical separation, are instead difficult to apply, due to the peculiar chemical-physical characteristics of copper.

For example, oxidative refining methods are scarcely applicable, as copper has a much lower affinity towards oxygen than that of iron, so that it tends to remain in the bath rather than separating as oxide in the slag.

Copper, therefore, cannot be separated with the slag, as happens with many other impurities present in the charge, such as sulfur and phosphorus for example.

This disadvantage is further worsened due to the great solubility of copper in iron at the melting temperatures of iron, typically around 1600° C.

Copper does not oxidize under the conditions of the iron smelting process, even in the presence of a supply of gaseous O₂ as a decarburant.

Oxidative refining processes are therefore unsuitable for separating copper, and typically no traces of copper are detected in the slag during the refining step.

Other methods proposed are based on the formation of copper sulfides, exploiting the fact that copper sulfide has greater stability than iron sulfide at temperatures higher than 600° C.; however, these methods entail disadvantages connected to the need to remove the sulfur residues from the bath.

Other known methods for removing copper, for example shown in Savov et al., RMZ—Materials and Geoenvironment, Vol. 50, No. 3, pages 627-640, 2003, exploit the different boiling temperature of metallic copper (1084° C.) compared to metallic iron (1538° C.) to remove the copper using vacuum distillation techniques.

However, the efficiency of these techniques is relatively low, and is also greatly influenced by the contact surface between the metal bath and the environment in which the vacuum is applied. It is also necessary that the head of the metal bath is free of slag, to facilitate the evaporation of the copper.

Additional known processes for removing copper, for example described in the patent document JP-04-221010 and in Hu et al., ISIL International, Vol. 53 (2013), No. 5, pages 920-922, provide to introduce chlorine-based reactive substances into the metal bath, in order to generate volatile copper chlorides.

However, the efficiency of these methods is severely limited by the fact that chlorine also reacts with iron, producing volatile iron chlorides.

This disadvantage greatly reduces the efficient removal of copper from the metal bath, since a large part of the chlorine-based reagent is lost due to the reaction with iron.

Moreover, the evaporation of the iron, which happens simultaneously with the evaporation of the copper, causes the ratio between copper and iron in the bath to vary very slowly.

Furthermore, these methods entail a loss of metallic material and therefore a waste of metal, in particular iron, needed for the production with consequent increase in costs.

In general, the known processes inherent in the removal of Cu both from solid scrap and from liquid steel do not lend themselves to large-scale industrial development, above all because of the low separation efficiencies and the high costs of implementing these methods in suitable apparatuses.

Document JP2008190010A discloses a method to remove copper dissolved in molten steel by adding polyvinylchloride (PVC) and then removing copper in gaseous form.

Document JPH04221010A discloses a method to remove copper in gaseous form from molten steel by adding chloride of alkali or alkaline earth metals.

Document Ali M. F., “Thermal and catalytic decomposition behavior of PVC mixed pklastic waste with petroleum residue”, J. Anal. Appl. Pyrolysis, vol. 74 (2005) 282-289 discloses the pyrolysis and hydropyrolysis of PVC mixed plastic waste alone and with petroleum residue carried out at 150 and 350° C. under N₂ gas and at 430° C. under 6.5 MPa H₂ gas pressure. This study shows that the catalytic coprocessing of PVC with vacuum gas (VGO) materials can be converted into transportation fuels. This document is therefore completely silent about removing copper from a bath of molten metal material in the steelmaking industry.

Document Uchida Y. et al., “Phase diagram of FeO-containing slags derived from activity measurements”, Proceedings of the Second International Conference on Processing Materials for Properties, TMS (The Minerals, Metals & Materials Society), 2000 discloses that the physical chemistry studies on iron and steelmaking process often require phase diagrams of FeO-containing slags. Isothermal section of the phase diagrams of such systems can be derived from experimental data for chemical potentials of FeO. Derivation of the phase diagrams of FeO-containing slags could be derived from the activity data for FeO, which can be measured through electrochemical technique involving stabilized zirconia. For example, isothermal section of the phase diagram of the system CaO—CaCl₂—FeO at 1623 K is given. However, also this document does not disclose removing copper from a bath of molten metal material in the steelmaking industry.

There is therefore a need to perfect a method to remove copper, to be used in the steel industry, which can overcome at least one of the disadvantages of the state of the art.

In particular, one purpose of the present invention is to provide a method to remove copper which is more efficient than the methods known in the state of the art, in particular that allows to remove enough copper, in a sufficiently short time, to allow the production of metal products also with a high steel content.

Another purpose of the present invention is to provide a method to remove copper which is cheaper than known methods.

In particular, one purpose of the present invention is to provide a method to remove copper which is adaptable to existing plants, and which therefore does not require large investments in order to be used.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, embodiments described here concern a method to remove copper from a bath of molten metal material and a reactive additive used therein, which overcome the limits of the state of the art and eliminate the defects present therein.

The removal method comprises:
adding to the bath a predetermined quantity of a reactive additive, comprising at least one chlorine compound able to react with copper present in the bath to produce volatile copper chlorides;
applying a depression to the bath to cause a selective removal of the copper chlorides producing the volatile copper chlorides which are extracted in gaseous form, removing the copper from the bath.

Advantageously, the removal method is selective toward copper since the copper is removed from the bath preferentially and in a predominant quantity with respect to other substances, in particular with respect to iron.

Advantageously, the removal method is selective toward copper since copper has a high reactivity toward the chlorine compound under the process conditions, it tends to volatilize due to the process temperature and to produce a vapor pressure higher than that of iron. Furthermore, gaseous copper generates volatile chlorides which can be removed by vacuum treatment.

Advantageously, the removal method provides that the addition of reactive additive is performed under slag, directly into the molten metal phase of the bath.

Other embodiments concern a method to produce cast metal products starting from molten metal material, which provides to selectively remove the copper from a bath of molten metal material, by means of the method to remove copper described here.

The production method comprises:
refining the molten metal material present in the bath;
subjecting the bath to vacuum degassing (VD) or Vacuum Oxygen Decarburizing (VOD);

The production method provides that the addition of the reactive additive is performed before the end of the refining and that the application of the depression to the bath is obtained by means of the vacuum degassing or vacuum oxygen decarburizing.

Advantageously, this production method can be used by exploiting existing plants and methodologies, with consequent reduction of investment and maintenance costs.

Other embodiments concern the reactive additive suitable to remove copper from the bath of molten metal material, comprising
at least one chlorine compound, or a mixture of chlorine compounds, in a percentage comprised between 60% and 90% in weight;
iron oxide, in a percentage comprised between 2% and 10% in weight.

### BRIEF DESCRIPTION OF THE DRAWINGS

These and other aspects, characteristics and advantages of the present invention will become apparent from the following description of some embodiments, given as a non-restrictive example with reference to the attached drawings wherein:

FIGS. 1-4 schematically show some steps of the method of the present invention, in accordance with some embodiments.

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

We will now refer in detail to the various embodiments of the invention, of which one or more examples are shown in the attached drawings. Each example is supplied by way of illustration of the invention and shall not be understood as a limitation thereof. For example, the characteristics shown or described insomuch as they are part of one embodiment can be adopted on, or in association with, other embodiments to produce another embodiment. It is understood that the present invention shall include all such modifications and variants.

Before describing these embodiments, we must also clarify that the present description is not limited in its application to details of the construction and disposition of the components as described in the following description using the attached drawings. The present description can provide other embodiments and can be obtained or executed in various other ways. Furthermore, we must clarify that the phraseology and terminology used here is for the purposes of description only, and cannot be considered as limitative.

The chemical symbols used in the present description, and in particular the symbols [symbol] , [symbol] and [symbol] , here have the meaning commonly understood in the formalism of chemical balances and known to a person of skill in the art, indicating, respectively, a generic chemical balance between reagents and products, a chemical balance partly or totally shifted toward the products, a chemical balance partly or totally shifted toward the reagents.

Embodiments described here concern a reactive additive suitable to remove copper from a liquid bath 10 of molten metal material, in particular molten steel.

In some embodiments, the reactive additive comprises at least one chlorine compound, or a mixture of chlorine compounds.

In some embodiments, the chlorine compound can be selected from a group comprising: alkaline-earth metal chlorides, silicon chlorides, alkaline-earth salts of chlorine oxyacids, or combinations thereof.

For example, calcium chloride (CaCl₂) and/or magnesium chloride (MgCl₂) can be used as alkaline-earth metal chlorides.

For example, silicon compounds which comprise one silicon atom linked to at least one chlorine atom can be used as silicon chlorides, in particular: SiCl₄ (tetrachlorosilane or silicon tetrachloride), SiCl₃H (silicon trichloride hydride or trichlorohydrosilane), SiCl₂H₂ (silicon dichloride dihydride or dichlorodihydrosilane), SiClH₃ (silyl chloride or chlorosilane).

The salts of the alkaline-earth metals of perchloric, chloric, chlorine, hypochlorous acid can be used as alkaline-earth salts of chlorine oxyacids, for example calcium hypochlorite (Ca(OCl)₂), or combinations thereof.

In some embodiments, the reactive additive comprises the at least one chlorine compound, or the mixture of chlorine compounds, between 60% and 90% in weight.

In some embodiments, the reactive additive can also comprise at least one oxide, or a mixture of oxides.

In particular, the reactive additive can comprise iron oxides (FeₓO_{y}), between 2% and 10% in weight.

In some embodiments, the iron oxide can be supplied by recycling the rolling scale or the slag.

In such embodiments, the reactive additive can comprise a fraction of wustite (FeO) greater than 90% in weight, magnetite (Fe₃O₄) between 2% and 6% in weight, the remaining part to reach 100% in weight consisting of hematite (Fe₂O₃).

Advantageously, as will become clearer hereafter in the description, the presence of iron oxide in the reactive additive allows to supply this compound, typically present in the slag 12, also in the metal phase 11, where the chlorination reactions occur.

In some embodiments, the reactive additive can comprise at least one acid oxide, for example silicon oxide (SiO₂), or a basic oxide, for example calcium oxide (CaO), between 10% and 30% in weight.

Advantageously, as will become clearer hereafter in the description, the presence of acid or basic oxides allows to compensate for possible acidity imbalances of the bath 10, in particular of the slag 12, due to the chlorination reactions.

For example, in the embodiments in which the chlorine compound comprises a silicon chloride, there can be provided a quantity of calcium oxide suitable to regulate the basicity of the slag.

Embodiments where the at least one chlorine compound comprises a combination of silicon chlorides and alkaline-earth metal chlorides and/or alkaline-earth salts of chlorine oxyacids, may not provide acid or basic oxides, since the chlorination reactions produce a mixture of acid and basic oxides.

Embodiments described here also concern a method to remove copper from a bath 10 of molten metal material, by means of the reactive additive, preferably but not exclusively to be used in the steel industry for the production of cast metal products.

Here and in the present description, with the expression “metal material” therefore we mean a material, for example steel, composed essentially of iron with the presence of other elements, such as carbon (C) and/or other alloy elements, and also comprising copper, which are both associated with impurities and also suitable to confer upon the cast metal product the desired characteristics.

For example, the metal material can comprise steels with different carbon contents, special steels, high alloyed steels, cast iron or other types of metal alloys.

As schematically shown in FIGS. 1-4, the bath 10 can be contained inside any container 14 whatsoever, known and unknown, suitable for steel use, such as a ladle or a ladle furnace (LF).

The liquid bath 10 comprises a liquid metal phase 11, containing iron and other elements in the metal state or as ions.

Furthermore, the bath 10 can comprise a slag 12, comprising iron and other elements in the form of oxides, typically disposed on the surface of the metal phase 11.

Although the presence of slag 12 is not essential for the applicability of the present invention, in this description it will be included since it is actually present in the practice of real applications.

Gaseous inclusions 13 can also be present in the metal phase 11 and/or in the slag 12, for example in the form of bubbles.

Here and in the present description the chemical species present in the metal phase 11 will be indicated in square brackets [.], the chemical species present in the slag 12 in round brackets (.), the chemical species present in gaseous form, for example in the gaseous inclusions 13, in braces {.}.

Due to the poor affinity with oxygen, the copper is present in minimal part in the slag 12, in the form of oxides, while it is almost completely contained in the metal phase 11, together with the metallic iron [Fe], as metallic copper [Cu].

The method of the present invention provides to add to the bath 10 a predetermined quantity of reactive additive, comprising the at least one chlorine compound, able to react with copper present in the bath 10 in liquid and/or gaseous form, in order to produce volatile copper chlorides.

In particular, the addition occurs in the metal phase 11 of the bath 10, in which copper is present. In particular, the addition of said at least one chlorine compound cane be advantageously performed under slag 12. In this way, any contact between the reactive additive and the slag 12 is avoided and a direct contact between the reactive additive and the molten metal phase 11 of the bath 10 of the bath 10 occurs instead. This is advantageous and important since in this way the method of the present invention avoids that the chloride components, if put into contact with the slag, are captured, thereby forming high melting point phases which often are non-reactive or scarcely reactive phases.

In some embodiments of the removal method, such predetermined quantity of reactive additive can be at least a stoichiometric quantity, calculated on the basis of the quantity of copper to be removed from the bath 10.

For example, if the objective is to obtain a molten metal material with a copper content lower than 0.4% in weight, starting from a bath 10 containing 0.5% in weight of copper, it is necessary to remove 20% of copper.

This quantity of copper can be removed by adding a quantity of reactive additive equal to 0.25% in weight, with respect to the total mass of the bath 10, for example 250 Kg of reactive additive per 100 t of bath 10.

In preferred embodiments, a predetermined quantity of reactive additive greater than the stoichiometric quantity is added, both to compensate for possible losses due to the suction of the reagents, as better clarified below, and also to provide excess reagent promoting the removal of copper.

In such embodiments, it is possible to add a predetermined quantity of reactive additive equal to 1% in weight with respect to the total mass of the bath 10, for example, 1 t of reactive additive per 100 t of bath 10.

In embodiments schematically described by FIG. 1, the addition can be performed by immersing an immersion lance 15 inside the bath 10, to a desired depth of delivery, which delivers the reactive additive in an Argon flow. Advantageously, by using the immersion lance 15 the addition of reactive additive can be performed under slag. In other words, by using the immersion lance 15 the reactive additive can be injected under slag, thereby avoiding any contact with the slag and obtaining a direct contact between the reactive additive and the molten metal phase 11 of the bath 10.

The depth of delivery can depend both on the construction characteristics of the plant, in particular of the container 14 in which the bath 10 is contained, and also on the composition of the bath 10, for example on the quantity of slag 12 present.

In some embodiments, the delivery can advantageously occur at a high depth of delivery, which allows to maximize the amount of time the reactive additive just delivered remains in the bath 10.

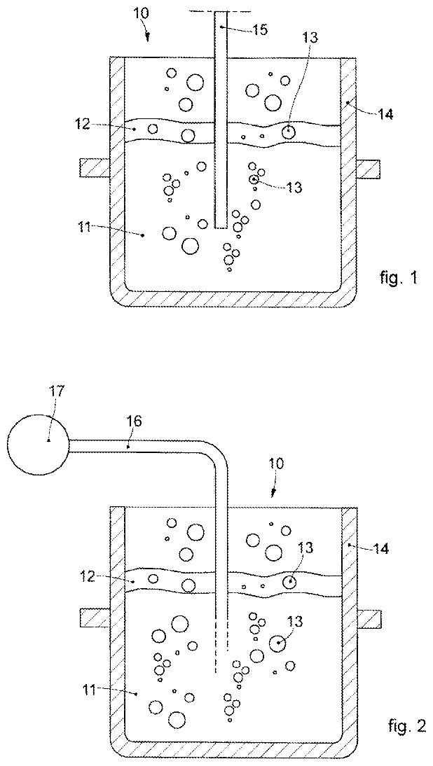

In alternative embodiments, schematically described by FIG. 2, the addition can be performed by immersing in the bath 10 a cored wire 16 containing the reactive additive inside, at a predetermined immersion speed, which depends on the desired depth of delivery.

In such embodiments, the cored wire 16 can be a flexible tube made of metal material, for example steel, internally hollow and with a reduced thickness, inside which the reactive additive is present in powder form.

The cored wire 16 can be unwound from a coil 17 at a predetermined immersion speed, of the order of a few meters per second.

When the cored wire 16 comes into contact with the bath 10, the metal material with which it is made begins to melt, gradually releasing the reactive additive, as schematically shown with the dotted line in FIG. 2. Advantageously, also in this case by using the cored wire 16, the addition of reactive additive can be performed under slag. Also in this case, by using the cored wire 16 the reactive additive can be added under slag, thereby avoiding any contact with the slag and obtaining a direct contact between the reactive additive and the molten metal phase 11 of the bath 10.

When the reactive additive is added to the bath 10, complex chemical processes occur, which can be schematized by way of example as copper chlorination reactions and/or iron chlorination reactions.

These reactions produce metallic iron, which enters the metal phase 11, oxides, which enter the possible slag 12 present or form a slag 12, volatile compounds, which can form gaseous inclusions 13 and bubble on the surface of the bath 10.

The volatile compounds can comprise volatile copper chlorides, for example CuCl₂ and/or CuCl, and volatile iron chlorides, for example FeCl₃.

The type of oxides produced depends on the type of the one or more chlorine compounds used in the reactive additive, in particular on the chlorine counterion, which is converted into oxygen counterion.

In particular, the alkaline-earth metal chlorides and the alkaline-earth salts of chlorine oxyacids can produce alkaline-earth metal oxides, basic, for example calcium oxide (CaO), magnesium oxide (MgO).

In particular, the silicon chlorides can produce silicon oxide (SiO₂), acid.

For example, when a reactive additive is used in which the chlorine compound is magnesium chloride, the chlorination of the copper can be schematized by way of example as

[MgCl₂]+[Cu]+[FeO] [symbol] (MgO)+{CuCl₂}+[Fe]

while the chlorination of the iron can be schematized by way of example

[MgCl₂]+[Fe]+[FeO] [symbol] (MgO)+{FeCl₂}+[Fe].

Advantageously, the iron oxide, typically present in the slag 12 phase, is supplied in the metal phase 11, in which the chlorinations occur, with the reactive additive.

Under conditions of ambient pressure and ambient or relatively low temperature, the chlorination of the copper with magnesium chloride would be thermodynamically disadvantaged.

In particular, the Applicant has verified that the reaction free energy associated with this reaction at atmospheric pressure and 100° C. is 82.550 kcal/mol, which corresponds to an equilibrium constant of 4.44×10⁻⁴⁹, indicating that in fact, the reaction does not occur.

The Applicant has also verified that the reaction free energy associated with this reaction at atmospheric pressure and 1500° C. is 1.922 kcal/mol, which corresponds to an equilibrium constant of 0.5795, indicating that the reaction occurs and that at the thermodynamic equilibrium there is a significant quantity of products, although smaller than the quantity of unreacted reagents.

At higher temperatures, in particular at 1600° C., the Applicant has verified that the reaction free energy is −2.241 kcal/mol, which corresponds to an equilibrium constant of 1.826, indicating that the reaction occurs and that at the thermodynamic equilibrium there is a significant quantity of products, larger than the quantity of unreacted reagents.

Embodiments of the method of the present invention therefore provide to maintain the bath 10 at a temperature comprised between 1500° C. and 1700° C.

The method of the present invention also provides to apply a depression to the bath 10, in order to cause a selective removal of the copper producing the volatile copper chlorides which are extracted in a gaseous form, thus removing the copper from the bath 10. The Applicant surprisingly found an increase in the efficiency and selectivity of the copper removal reaction in combination with the addition of the chlorine compound(s) into the metal phase 11 of the bath 10.

In this description, with the expression “apply a depression” we mean the application of any vacuum degree whatsoever.

In some embodiments, the depression can be a low vacuum degree, for example comprised between 10⁵ Pa and 10² Pa, or a medium vacuum degree, for example comprised between 10³ Pa and 10⁻¹ Pa.

In preferred embodiments, the depression is comprised between 50 Pa (0.5 mbar) and 1000 Pa (10 mbar), in particular 100 Pa (1 mbar) and 1000 Pa (10 mbar).

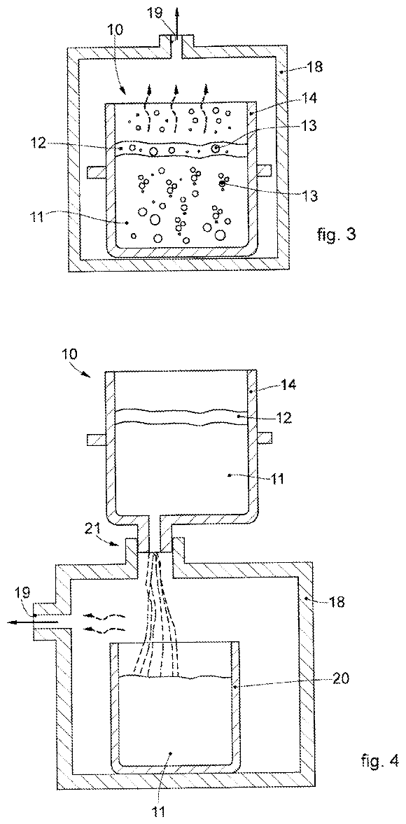

In embodiments schematically described by FIG. 3, the application of the depression can be performed by placing the container 14 in a sealed chamber 18, or autoclave, which can be hermetically sealed and is suitable for the vacuum seal, which has an aperture 19 to which vacuum generation means are connected, not shown in the drawing.

Alternative embodiments, not shown, can provide that the container 14 is provided with a lid, which can be hermetically sealed and is suitable for the vacuum seal, which has the aperture 19 for the connection with the vacuum generation means. In these embodiments, therefore, the sealed chamber 18 is not provided.

The vacuum generation means, for example pumps, suck out the volatile substances contained in the container 14 and/or in the sealed chamber 18, in the direction indicated by the continuous arrow in the drawing.

The suction of the volatile substances reduces the vapor pressures of the substances contained in the bath 10, inducing a greater bubbling of the gaseous inclusions 13, as schematically shown by the dashed arrows.

The efficiency of the application of the depression depends on the surface of the bath 10 exposed to the vacuum, which, in the embodiments described by FIG. 3 is determined by the head of the slag 12.

In some embodiments, not shown, it is also possible to agitate the bath 10 by means of magnetic agitators and/or by insufflation of inert gas, for example Argon, which causes bubbling, increasing its turbulence. This solution, by increasing the turbulence, promotes the suction of the volatile substances, in particular volatile copper chlorides.

Furthermore, under the described pressure and temperature conditions, the phase transition of the copper and iron from the metal phase 11 to the gaseous inclusions 13 is promoted.

Advantageously, due to the higher vapor pressure of copper (1.26 mbar) compared to iron (0.08 mbar) at process temperatures, the fraction of copper which passes into the gaseous inclusions 13 is much greater than the fraction of iron which passes into the gaseous inclusions 13.

Schematically:

[Cu] [symbol] {Cu}

[Fe] [symbol] {Fe}

Since the chlorination reaction is more efficient in the gaseous phase than in the liquid phase, both in thermodynamic and also kinetic terms, the copper reacts preferentially compared to iron.

The application of the depression and the suction of the volatile compounds produces a disturbance of the liquid/gaseous phase equilibria. The bath 10 reacts to this disturbance, according to Le Chatelier's Law, releasing further volatile copper compounds, in greater quantities than the volatile iron compounds, which are in turn again suctioned and removed. This mechanism therefore causes an increase in the efficiency of the separation of copper.

The chlorine compound of the reactive additive can therefore react both with the copper contained in the bath 10, in a competitive manner with the iron contained in the bath 10, and also with the copper contained in the gaseous inclusions 13, in a prevalent quantity with respect to the iron contained in the gaseous inclusions 13, improving the selectivity of the chlorination.

Schematically:

[Cu] [symbol] {Cu} [symbol] {CuCl₂}

[Fe] [symbol] {Fe} [symbol] {FeCl₃}

In addition, the application of the depression can also promote the volatilization in the gaseous inclusions 13 of the one or more chlorine compounds, removing it, at least in part, from the bath 10, further inhibiting the reaction with iron and further promoting the reaction with the copper.

The application of the depression also removes the reaction products from the gaseous phase, further promoting the volatilization from the bath 10.

As an indication, already at ambient pressure the boiling temperatures of magnesium chloride and of the silicon chlorides are much lower than the process temperatures, dropping further with the decrease in pressure.

In addition, the amount of time the chlorine compound remains in the bath 10 is maximized in the manners described previously, while the corresponding volatile compounds are quickly removed with the application of the depression, promoting the reaction.

The combination of the addition of the chlorine compound in the bath 10 and the application of the depression therefore produces an advantageous synergistic effect, which goes beyond the simple sum of the two effects, taken separately.

In particular, in the absence of such synergistic effect, the application of the depression would lead to a simple increase in the quantity of volatile copper and iron chlorides removed, without affecting the relative percentages.

Instead, the synergistic effect modifies the reactivity of the system making it more selective toward copper, that is, promoting chlorination of the copper and inhibiting chlorination of the iron.

The application of the depression therefore allows to obtain a selective chlorination of the copper, which can therefore be selectively extracted in the form of volatile chlorides by suction.

By way of example, the Applicant has verified that by applying a depression of 20000 Pa (200 mbar), even maintaining the bath 10 in agitation, it is not possible to remove more than 1% in weight of the copper present in the bath 10. By applying instead a depression of, for instance, 1000 Pa (10 mbar) and keeping the bath 10 in agitation, it is possible to subtract up to 20% in weight of copper.

In some embodiments, the depression can be applied to the bath 10 for a period of time comprised between 5 min and 60 min.

In particular, the Applicant has verified that it is possible to remove between 20% and 60% of copper from the bath 10, applying a pressure comprised between 100 Pa and 1000 Pa for a period of time comprised between 5 and 60 min.

Other embodiments concern a method to produce cast metal products starting from molten metal material, which provides to selectively remove copper from a bath 10 of molten metal material, by means of the method to remove copper described here.

In some embodiments, the production method comprises:
refining the molten metal material present in the bath 10;
subjecting the bath 10 to vacuum degassing (VD) or Vacuum Oxygen Decarburizing (VOD).

In some embodiments of the production method, the bath 10 of molten metal material can be obtained by melting, starting from the metal material.

The metal material can for example be supplied as scrap or as a material derived from iron minerals subjected to reduction, for example DRI (Direct Reduced Iron) or HBI (Hot Briquetted Iron).

The scrap can include waste material originating from other steel works, such as waste from rolling or scrap from cuttings of long products, possibly produced in the same plant (home scrap) or in different plants, or it can also come from demolitions of industrial plants or rolling stock, railway, shipbuilding, machinery material.

The scrap can also come from obsolete consumer products intended for disposal, for example automobile parts, ferrous components of household appliances or furniture components such as bed bases, or even electronic components or electric motors rich in copper.

In some embodiments, the metal material can be melted in a furnace, for example an induction furnace or an electric arc furnace, and then poured into a ladle, or into another suitable container 14.

In alternative embodiments, the metal material can be melted directly in a suitable container 14, for example in a ladle furnace.

The refining can provide selective oxidation processes, of a known type, aimed at separating from the molten metal material possible impurities that have high affinity toward oxygen, in the form of oxides, for example carbon, silicon, manganese, phosphorus, which proceed to form, or feed, the slag 12.

In some embodiments, the refining can provide to add basic oxides to the molten metal material, such as for example calcium oxide (CaO), magnesium oxide (MgO), and/or acid oxides, such as for example silicon oxide (SiO₂).

In some embodiments, the refining can also comprise other processes, such as desulphurization and/or dephosphorization.

In particular, the refining can provide selective desulphurization processes, of a known type, aimed at separating from the molten metal material possible impurities that have high affinity toward sulfur in the form of sulfides, which proceed to form, or feed, the slag 12.

The refining is typically performed by maintaining the bath 10 at a temperature comprised between 1500° C. and 1700° C.

In some embodiments, the production method provides that the addition of the reactive additive is performed before the end of the refining, and that the application of the depression is obtained by the same vacuum degassing (VD) or Vacuum Oxygen Decarburizing (VOD).

In some embodiments, the predetermined quantity of additive, stoichiometric or in excess, as previously described, can depend on the concentration of copper to be obtained in the cast metal products.

In some embodiments, the addition can be performed between 5 min and 15 min before the end of the refining.

The selective chlorination of the copper can therefore extend for a reaction time substantially corresponding to the vacuum degassing time, or vacuum oxygen decarburizing time, plus the time of the final steps of the refining (for example 5-15 min).

Advantageously, the fact that the addition of the reactive additive is performed at the end of the refining allows to obtain the temperatures provided by the method to remove copper without needing to perform further heatings compared to those already provided in the methods to produce cast products.

Advantageously, the fact that the application of the depression is obtained by means of vacuum degassing, or vacuum oxygen decarburizing, allows to obtain the vacuum degrees provided by the method to remove copper without performing further vacuum applications compared to those already provided by the methods to produce cast products. Advantageously, the gaseous copper can be removed via the Vacuum Degassing (VD) or Vacuum Oxygen Decarburizing (VOD) used to obtain the desired depression.

The method to produce cast metal products of the present invention can therefore be applied without modifying pre-existing processes and plants.

In embodiments in which the refining provides to supply at least one basic oxide, the quantity of the at least one basic oxide supplied can be smaller than the necessary quantity, the missing part being produced by the selective chlorination of the copper.

In particular, this solution can be obtained by using a reactive additive which contains alkaline-earth metal chlorides and/or alkaline-earth salts of chlorine oxyacids, since the corresponding chlorination reactions generate basic oxides.

By way of example, the Applicant has verified that by providing a reactive additive that contains 70% of calcium chloride, and adding it in a ladle furnace in a quantity equal to 1% with respect to the mass of the molten metal material, it is possible to supply, during the refining step, 20% less lime.

In some embodiments, the quantity of silicon oxide present in the reactive additive can be adjusted in such a way as to balance the variation of the acidity of the slag 12 associated with the production of basic oxides in the chlorination reactions, thus preserving the refractory materials of the apparatuses of the plant and also better regulating the chemical conditions of the bath 10.

In some embodiments, the application of the depression can be performed by means of the apparatuses and methodologies commonly used for the operations of vacuum degassing, or vacuum oxygen decarburizing, of the bath 10, in order, for example, to lower the hydrogen and/or nitrogen content.

The vacuum degassing or vacuum oxygen decarburizing, in addition to the application of the depression, can also provide other operations, such as mixing or agitation, for example by means of a magnetic agitator, bubbling of inert gases, in order to generate turbulence and increase the surface/volume ratio of the bath 10.

In some embodiments, the volatile copper chlorides are transformed into powders by gradual cooling to ambient temperature and eliminated by filtration.

For example, the Applicant has verified that in some embodiments of the method of the present invention, a mixture of cuprous chloride (CuCl) and cupric chloride (CuCl₂) was suctioned. These compounds were then solidified and disposed of as dust by cooling them to lower temperatures, respectively, of 422° C. and 100° C., using the standard gas treatment and dedusting plant.

In some embodiments, the molten metal material can be cast by means of known apparatuses and methods.

In some embodiments, the production method can also provide to cast the molten metal material by applying a depression, and selectively extracting the copper in the form of volatile copper chlorides.

As shown by way of example in FIG. 4, the molten metal material can be cast and transferred into a second container 20, located in the sealed chamber 18, the latter connected to the container 14 by means of suitable sealed connection means 21.

This solution allows to increase the efficiency of the vacuum degassing, or vacuum oxygen decarburizing, and of the application of the depression to remove the copper chlorides, because when the jet of molten metal material cast under vacuum breaks up into droplets, the useful surface/volume ratio increases.

In these embodiments, the selective chlorination of the copper can extend for a reaction time substantially corresponding to the degassing time, plus the time of the final steps of the refining (for example 5-15 min), plus the time of vacuum casting.

Advantageously, as the duration of the vacuum application increases, the efficiency of the chlorination of the copper increases, and a greater quantity of copper is removed.

It is clear that modifications and/or additions of steps and parts may be made respectively to the method and to the reactive additive as described heretofore, without departing from the field and scope of the present invention as defined by the claims.

It is also clear that, although the present invention has been described with reference to some specific examples, a person of skill in the art shall certainly be able to achieve many other equivalent forms of method and reactive additive, having the characteristics as set forth in the claims and hence all coming within the field of protection defined thereby.

In the following claims, the sole purpose of the references in brackets is to facilitate reading: they must not be considered as restrictive factors with regard to the field of protection claimed in the specific claims.

1. A method to remove copper from a bath of molten metal material, said method comprising:
adding to said bath a predetermined quantity of a reactive additive, comprising at least one chlorine compound able to react with copper present in said bath to produce volatile copper chlorides;
applying a depression, comprised between 50 Pa (0.5 mbar) and 1000 Pa (10 mbar), to said bath to cause a selective removal of the copper chlorides producing said volatile copper chlorides which are extracted in gaseous form, removing the copper from said bath.

2. The removal method as in claim 1, wherein said depression is comprised between 100 Pa (1 mbar) and 1000 Pa (10 mbar).

3. The removal method as in claim 1, wherein said bath is maintained at a temperature comprised between 1500° C. and 1700° C.

4. The removal method as in claim 1, wherein said depression is applied to said bath for a period of time comprised between 5 min and 60 min.

5. The removal method as in claim 1, wherein said bath is maintained in agitation by means of insufflation of inert gas that causes bubbling, increasing its turbulence.

6. The removal method as in claim 1, wherein said addition of reactive additive is performed under slag, directly into the molten metal phase of the bath.

7. The removal method as in claim 6, wherein said addition is performed by immersing in said bath a cored wire, containing inside it said reactive additive, at a predetermined immersion speed, which depends on the desired depth of delivery.

8. The removal method as in claim 6, wherein said addition is performed by immersing an immersion lance inside said bath, to a desired depth of delivery, which delivers said reactive additive in an argon flow.

9. The removal method as in claim 1, wherein said reactive additive comprises the at least one chlorine compound between 60% and 90% in weight and iron oxide, between 2% and 10% in weight.

10. The removal method as in claim 1, wherein said at least one chlorine compound is selected from a group comprising: alkaline-earth metal chlorides, silicon chlorides, alkaline-earth salts of chlorine oxyacids, or combinations thereof.

11. The removal method as in claim 1, wherein said reactive additive further comprises at least one acid oxide, in particular silicon oxide, or a basic oxide, in particular calcium oxide, between 10% and 30% in weight.

12. A method to produce cast metal products starting from molten metal material, wherein it provides to selectively remove the copper from a bath of molten metal material, by means of a method to remove copper according to claim 1.

13. The production method as in claim 12, comprising:
refining said molten metal material present in the bath;
subjecting said bath to vacuum degassing or vacuum oxygen decarburizing;
wherein
said addition is performed before the end of said refining and said application of a depression is obtained by means of said vacuum degassing or vacuum oxygen decarburizing.

14. The production method as in claim 13, wherein said addition is performed between 5 min and 15 min before the end of said refining.

15. The production method as in claim 13, wherein said refining provides to supply at least one basic oxide, wherein the quantity of the at least one basic oxide supplied is lower than the necessary quantity, the missing part being produced by said selective chlorination of the copper.

16. The production method as in claim 13, wherein it further comprises
casting said molten metal material by applying a depression and selectively extracting the copper in the form of volatile copper chlorides.

17. The production method as in claim 13, wherein said volatile copper chlorides are transformed into powders by means of gradual cooling to room temperature and eliminated by filtration.

18. A reactive additive suitable to remove copper from a bath of molten metal material, comprising
at least one chlorine compound, or a mixture of chlorine compounds, between 60% and 90% in weight;
iron oxide, between 2% and 10% in weight.

19. The reactive additive as in claim 18, wherein said at least one chlorine compound is selected from a group comprising: alkaline-earth metal chlorides, silicon chlorides, alkaline-earth salts of chlorine oxyacids, or combinations thereof.

20. The reactive additive as in claim 18, wherein it further comprises at least one acid oxide, in particular silicon oxide, or a basic oxide, in particular calcium oxide, between 10% and 30% in weight.
